(19) United States
(12) Patent Application Publication
(10) Pub. No.: US 2009/0063176 A1
(43) Pub. Date: Mar. 5, 2009

(54) SHOPPING CART BASKET MONITOR

(76) Inventors: John R. French, San Diego, CA (US); Joseph F. Nebolon, Del Mar, CA (US); Robert M. Harling, Valley Center, CA (US)

Correspondence Address: NYDEGGER & ASSOCIATES, 348 OLIVE STREET, SAN DIEGO, CA, 92103, US

(21) Appl. No.: 11/849,063

(22) Filed: Aug. 31, 2007

(51) Int. Cl. G06Q 30/00

(52) U.S. Cl. 705/1

(57) ABSTRACT

A system prevents non-payment for goods carried through a checkout aisle in a shopping cart. In the system, a scale determines the end-weight of the cart after all goods are presumably removed. Further, a controller compares the end-weight and the tare weight of the cart. When theft is suspected, a camera captures an image of the cart while an indicator at the checkout location alerts the cashier to inspect the cart for unremoved goods. Specifically, the controller creates a signal when the end-weight exceeds the tare weight to instruct the camera to capture the image and to activate the indicator to alert the cashier. The controller may include or be integrated into a network accessible by store management or outside security advisors to examine the performance of cashiers and to determine possible patterns or profiles for theft.

### FIELD OF THE INVENTION

The present invention pertains generally to theft prevention devices and to methods of using such devices. More particularly, the present invention pertains to theft prevention devices that ensure shopping carts are completely emptied at checkout locations. The present invention is particularly, but not exclusively, useful as a theft prevention device that monitors and compares the weight of a presumably empty shopping cart with the cart's tare weight to determine whether the cart is empty at the checkout location.

### BACKGROUND OF THE INVENTION

Shoplifting continues to be a major issue for retailers. In fact, more than $13 billion worth of goods are stolen from retailers in the U.S. each year, i.e., more than $25 million worth of goods per day. While shoplifting often connotes clandestine attempts to hide and carry goods out of the store, often goods are stolen in a more patent manner. Specifically, goods may be kept on the bottom shelf of a shopping cart during checkout, and then carried out of the store without being paid for. Due to the non-concealed nature of this act, the shoplifter can allege innocence if apprehended for theft. Further, cashiers at the checkout counter can purposely fail to scan goods on the bottom shelf of the shopping cart as a “sweetheart deal” for family and friends. This causes particular financial loss for the store when such thefts involve expensive goods; for example, baby formula.

In light of the above, it is an object of the present invention to provide a system and method for preventing a non-payment for goods, when the goods are carried in a shopping cart to a checkout location. Another object of the present invention is to provide a theft prevention system that alerts a cashier at a checkout location to inspect a presumably empty shopping cart. Still another object of the present invention is to provide a theft prevention system that records instances of suspected theft and captures images of presumably empty carts to deter complicity in theft by cashiers. It is another object of the present invention to provide a theft prevention method and system that is easy to implement, cost effective and simple to use.

### SUMMARY OF THE INVENTION

In accordance with the present invention, a system is provided for preventing non-payment for goods carried in a shopping cart to a checkout location. The system includes a camera positioned at the checkout location to create a visual record (image) of the cart. In the system, the camera may be automatically triggered to record an image of the cart by motion or weight sensors or by actions by the cashier at the checkout location. Further, the camera is in electronic communication with a controller, which is, in turn, in communication with the register at the checkout location. Importantly, the controller is able to create a date-time-location stamp for the visual record of the cart.

In certain embodiments, the system also includes a scale for determining the end-weight of the cart after all goods are presumably removed at the checkout location. For the system, the controller receives the end-weight from the scale. For purposes of the present invention, the controller is provided to compare the end-weight to the known tare weight of the cart. When the end-weight exceeds the tare weight, the controller creates a signal. Further, the system includes an indicator. In response to the signal, the indicator alerts a cashier to inspect the cart for unremoved goods. Also, in response to the signal, the camera records an image of the cart. For the present invention, the indicator and camera are in electronic communication with the controller. In operation, the indicator and the camera receive the signal from the controller.

During operation of an embodiment of the system, a loaded cart enters the checkout location causing the camera to capture an image of the cart. This image is stored by the controller and marked with a date-time-location stamp. Further, the cart is weighed by the scale. As goods are removed from the cart, the scale continues to monitor the weight of the cart. When all goods have been presumably removed from the cart, the scale determines the end-weight of the cart.

After the end-weight of the cart has been determined, it is communicated to the controller. The controller then compares the end-weight to the known tare weight of the cart. If the end-weight exceeds the tare weight by a predetermined percentage or a value (i.e. cumulative weight decrement), the controller creates a signal that is communicated to the camera and to the indicator. In response to the signal, the camera captures an image of the cart and transmits the image to the controller. When the image is received, the controller creates and stores the end-weight, tare weight, counter location, image, and date-time stamp. Further, in response to the signal, the indicator alerts the cashier at the checkout location to inspect the cart for unremoved goods.

In addition to the camera and cart-weighing components of the system, the system includes a scale mounted at the tabletop of the cashier stand to record the weight of goods before they are bagged. Further, the scale is connected to the controller. As a result, the controller may ensure that all goods placed on the tabletop scale were subjected to completed transactions, i.e., the price of the goods was first entered into the cash register. Typically, goods are scanned, with the price automatically entered into the register during the transaction.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an overhead schematic view of an embodiment of a system for preventing non-payment for goods in a shopping cart in accordance with the present invention;

FIG. 2 is a perspective view of an alternate embodiment of the scale of the system of FIG. 1 wherein a scale is mounted directly on a shopping cart in accordance with the present invention;

FIG. 3 is an operational flow chart illustrating the method of an embodiment of the present invention; and

FIG. 4 is an operational flow chart illustrating the method of an embodiment of the present invention.

### DESCRIPTION OF THE PREFERRED EMBODIMENTS

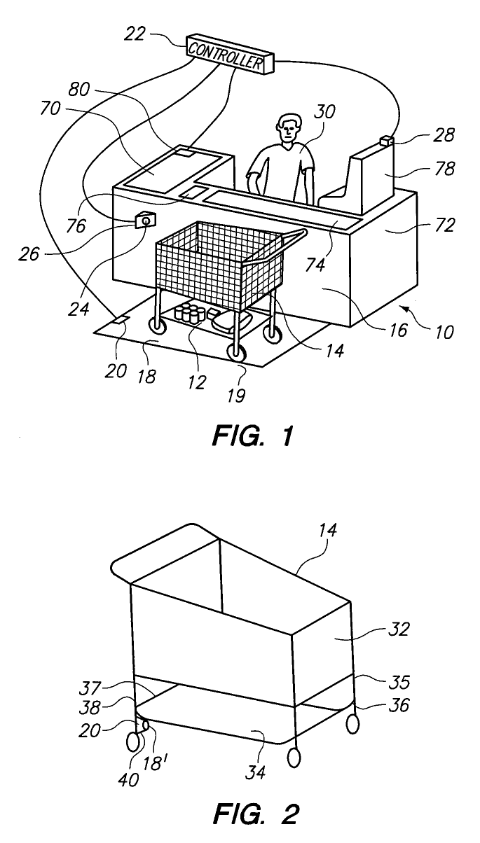

Referring initially to FIG. 1, a system for preventing theft is shown, and is generally designated 10. More specifically, the system 10 is used to prevent non-payment for goods 12 that are being carried in a shopping cart 14, when the goods 12 are brought to a checkout location 16. As shown, the system 10 includes a scale 18 that is used to weigh the cart 14 before, during and after the goods 12 have been removed from the shopping cart 14 for checkout. For a preferred embodiment of the present invention, the scale 18 is embedded in the floor 19 and includes a transmitter/receiver 20 that is in electronic communication, preferably via radiofrequency, with a controller 22. In the embodiment shown in FIG. 1, both the scale 18 and transmitter/receiver 20 are mounted in the floor 19 at the checkout location 16. This configuration allows the cart 14 to be rolled onto the scale 18. Further, the system 10 includes a camera 24 that can be mounted as desired, to capture an image of the bottom shelf or lower portion of the cart 14, when goods 12 remain on the cart 14 after the cart 14 has presumably been emptied. In order to communicate with the controller 22, the camera 24 includes a transmitter/receiver 26. In addition to previously recited components (i.e. the scale 18, the controller 22, and the camera 24), the system 10 includes an indicator 28 that is used to alert the cashier 30 when the cart 14 has not been fully emptied. Specifically, the indicator 28 may comprise an audible or visual alarm for alerting the cashier 30.

Referring now to FIG. 2, an alternate embodiment of the scale 18′ is illustrated. As shown, the scale 18′ is mounted directly on a shopping cart 14. Specifically, in this case, the shopping cart 14 includes a main basket 32 and a bottom shelf 34. As shown, the bottom shelf 34 is supported at the cart's front end 35 by a hinge 36, while the bottom shelf 34 is unattached at its rear end 37. Further, the cart 14 includes legs 38 that have ears 40. In FIG. 2, it can be seen that the scale 18′ and transmitter/receiver 20 are positioned on the ear 40. As a result, when goods 12 are loaded onto the bottom shelf 34, the rear end 37 of the shelf 34 contacts the ears 40 and the scale 18′ registers the weight of the goods 12.

In operation, a cart 14 is positioned at a checkout location 16. As a result, the camera 24 is activated to create a visual record of the cart 14. Activation may be automatically triggered by the scale 18, by a motion sensor mounted in the camera 24, by actions of the cashier 30, or the camera 24 may be_programmed to record images according to a schedule. Regardless of the activation method employed, each recorded image is communicated to the controller 22 and is marked by the controller 22 with a date-time-location stamp. As a result, a sequence of images may be reviewed to determine whether goods 12 were left in a cart 14 without being checked out by a cashier 30.

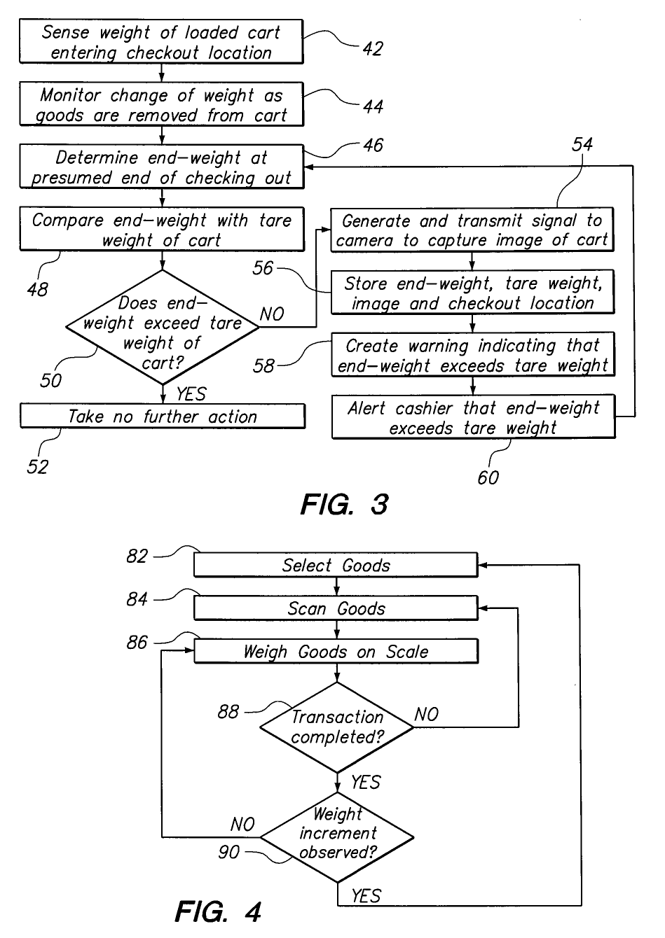

Referring now to FIG. 3, the operation of an embodiment of the system 10 may be understood. In accordance with the methodology shown in FIG. 3, the initial weight of the loaded cart 14 is sensed by the scale 18. This is accomplished when the cart 14 enters the checkout location 16 (action block 42). In action block 44, the scale 18 continues to monitor the change of weight of the cart 14 as goods 12 are removed for checkout. Thereafter, the scale 18 determines the end-weight of the cart 14 which is now presumably empty (action block 46). For the present invention, after the unloading of a cart 14 has begun, the cart 14 may be presumed to be empty when its weight remains static for a predetermined period of time. The cart 14 is also presumed to be empty when the cashier 30 finalizes the sale of goods 12. There may also be other mechanisms for making this determination. In any event, after the end-weight is determined, it is communicated to the controller 22 by the transmitter/receiver 20. Then, the controller 22 compares the end-weight with the known tare weight of the cart 14 (action block 48). As shown in inquiry block 50, it is determined if the end-weight exceeds the tare weight of the cart 14. More specifically, the controller 22 may determine whether the end-weight exceeds the tare weight by a certain percentage, such as by 3%. For a typical forty-five pound cart 14, 3% translates to an accuracy of within about twenty ounces.

If the end-weight does not exceed the tare weight, then all goods 12 have been emptied from the cart 14 and no further action is taken (action block 52). On the other hand, if the end-weight is considered to exceed the tare weight, then the controller 22 generates and transmits a signal to the camera 24 to capture an image of the cart 14. More specifically, this image will include the bottom shelf 34 (action block 54). The image is transmitted to the controller 22 by the transmitter/receiver 26 and the controller 22 stores the image, end-weight, tare weight, and checkout location (action block 56). The signal is also transmitted to the indicator 28 at the checkout location 16 (action block 58). As a result, the indicator 28 alerts the cashier 30 that the end-weight exceeds the tare weight and that the cashier 30 must inspect the cart 14 for unremoved goods 12 (action block 60). Further, the indicator 28 makes the cashier 30 aware of surveillance to ensure all goods 12 are checked out.

For the embodiment illustrated in FIG. 2, the tare weight may be considered to be zero, and the loaded cart weight and end-weight include only the force exerted by the bottom shelf 34 on the scale 18′. As a result, the scale 18′ may utilize a trigger weight of twenty ounces before registering that an end-weight exceeds the tare weight. Nevertheless, the scale 18′ operates in essentially the same way as the scale 18 of FIG. 1 with regard to preventing goods 12 from being carried out on the bottom shelf 34 of the cart 14 without being paid for.

As shown in FIG. 1, for certain embodiments, the system 10 may include a scale 70 at the checkout location 16 for weighing goods 12 removed from the shopping cart 14. As shown, the cashier stand 72 at the checkout location 16 includes a conveyor 74 onto which goods 12 are typically transferred from the shopping cart 14. In addition, the cashier stand 72 includes a scanner/scale 76 for electronically reading and, if necessary, weighing each good 12, to perform a transaction and register the price of the good 12. Accordingly, the scanner/scale 76 is electronically connected to a cash register 78 for recording the transaction and receiving and totaling the costs of the goods 12. As shown in FIG. 1, the scale 70 is provided at the cashier stand 72 to receive and weigh each good 12 after it has been moved from the conveyor 74 and past the scanner/scale 76. As further shown, the scale 70 may include a transmitter/receiver 80 that is in electronic communication, preferably via radiofrequency, with the controller 22 and the register 78. In the embodiment shown in FIG. 1, both the scale 70 and transmitter/receiver 80 are mounted in the cashier stand 72.

Referring to FIG. 4, the use of the scale 70 is demonstrated. In action block 82, the cashier 30 selects goods 12 from the conveyor 74 or the cart 14. Then, the cashier 30 scans the selected goods 12 with the scanner/scale 76 to perform a transaction (action block 84). During the transaction, the price of the goods 12 is electronically determined, and is inputted to the cash register 78 as a transaction entry. Thereafter, the cashier 30 places the scanned goods 12 onto the scale 70 and the scale 70 communicates receipt of the goods 12 to the controller 22 (action block 86). As a result, the controller 22 is prompted to identify whether a transaction has been completed for the goods 12 added to the scale 70 (inquiry block 88). For example, the controller 22 may determine whether the goods 12 were added to the scale 70 after a transaction within a defined time period such as five seconds, without any intervening addition of goods 12 to the scale 70. If no completed transaction can be correlated to the goods 12 that are placed on the scale 70, the controller 22 issues a warning to alert the cashier 30 to scan the goods 12 at step 84. If the goods 12 were added to the scale 70 after a completed transaction, then the controller 22 determines whether a weight increment is observed (inquiry block 90). If a weight increment is not observed, the controller 22 alerts the cashier 30 to reposition the goods 12 on the scale 70 at step 86. If a weight increment is observed, then the cashier 30 repeats the process for other goods 12 until all goods 12 have been scanned and weighed.

As a result, the system 10 prevents goods 12 from being accidentally or purposefully placed on the scale 70 without first being scanned by scanner/scale 76 during a transaction. Further, the controller 22 stores a record of each transaction, each weight increment, each warning, and the respective checkout location 16. In this manner, the system 10 ensures that all goods 12 are scanned before being placed on the scale 70.

After all goods 12 have been placed on the scale 70, the final weight of the goods 12 is recorded by the scale 70 and communicated to the controller 22. As a result, the controller 22 may determine the cumulative weight of the final weight of the goods 12 and the end-weight of the cart 14. Further, the controller 22 can compare the determined cumulative weight to the initial weight of the loaded cart 14 when it entered the checkout location 16. If there is a discrepancy, the controller 22 creates a warning and transmits the warning to the indicator 28 at the checkout location 16. Further, the controller 22 stores the final weight of the goods 12, the end-weight of the cart 14, the initial weight of the loaded cart 14, the checkout location 16, the date and the time.

Alternatively, the system 10 may only ascertain the final weight of all goods 12 that have been placed on the scale 70. Further, the controller 22 can calculate an expected weight for the goods 12 based on the transactions entered at the register 78. Then, the controller 22 compares the ascertained weight and the expected weight for the goods 12. If there is a discrepancy, the controller 22 creates a warning and transmits the warning to the indicator 28 at the checkout location 16. Further, the controller 22 stores the ascertained weight of the goods 12, the expected weight of the goods 12, the checkout location 16, the date and the time.

For each embodiment disclosed, the controller 22 may include or be integrated into a network accessible by store management or outside security advisors. As a result, each instance of the creation of a signal or warning may be examined to review the performance of cashiers 30. Specifically, the circumstances regarding each signal or warning, e.g., the associated weights, images, dates, times and checkout locations, can be evaluated to determine possible patterns of behavior or to create profiles for certain types of theft.

While the particular Shopping Cart Basket Monitor as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for preventing non-payment for goods in a shopping cart comprising the steps of:
identifying a tare weight for the cart;
determining an end-weight for the cart after all goods are presumably removed from the cart at a checkout location;
comparing the end-weight with the tare weight; and
creating a signal when the end-weight exceeds the tare weight, with said signal alerting a cashier at the checkout location to inspect the cart for unremoved goods.

2. A method as recited in claim 1 further comprising the step of capturing an image of the cart in response to the signal.

3. A method as recited in claim 2 further comprising the step of storing the image, the tare weight, the end-weight, and the checkout location.

4. A method as recited in claim 1 further comprising the steps of:
sensing an initial weight of the cart holding the goods when the cart enters a checkout location; and
monitoring a change of cart weight as the goods are removed from the cart.

5. A method as recited in claim 1 wherein the end-weight is considered to exceed the tare weight when the end-weight is greater than 103% of the tare weight.

6. A method as recited in claim 1 further comprising the steps of:
monitoring a transaction entered at a register for each good removed from the cart at the checkout location;
observing a weight increment for each good removed from the cart and positioned for bagging at the checkout location;
ensuring that each observed weight increment is correlated to a respective transaction; and
creating a warning when the observed weight increment does not correlate to a respective transaction.

7. A method as recited in claim 1 further comprising the steps of:
recording each good removed from the cart in a transaction entry;
positioning each recorded good at the checkout location for bagging;
ascertaining the weight of the goods at the checkout counter;
calculating the expected weight of the goods from the transaction entries;
comparing the ascertained weight with the expected weight; and
creating a warning when the ascertained weight exceeds the expected weight, with said warning alerting a cashier at the checkout location to inspect the checkout location for unrecorded goods.

8. A method as recited in claim 7 further comprising the step of storing the ascertained weight, the expected weight, the checkout location, the date and the time.

9. A system for preventing non-payment for goods in a shopping cart comprising:
means for identifying a tare weight for the cart;
means for determining an end-weight for the cart after all goods are presumably removed from the cart at a checkout location;
means for comparing the end-weight with the tare weight; and
means for creating a signal when the end-weight exceeds the tare weight, with said signal alerting a cashier at the checkout location to inspect the cart for unremoved goods.

10. A system as recited in claim 9 further comprising a camera for capturing an image of the cart in response to the signal, with said camera being electronically connected to the controller.

11. A system as recited in claim 10 further comprising a means for storing the image, the tare weight, the end-weight, the checkout location, the date and the time.

12. A system as recited in claim 9 wherein the determining means is a scale, wherein the comparing means and the creating means is a controller, and wherein the controller is electronically connected to the scale.

13. A system as recited in claim 9 further comprising:
means for monitoring a transaction entered at a register for each good removed from the cart at the checkout location;
means for observing a weight increment for each good removed from the cart and positioned for bagging at the checkout location;
means for ensuring that each weight increment is correlated to a respective transaction; and
means for creating a warning when the observed weight increment does not correlate to a respective transaction.

14. A system as recited in claim 9 further comprising:
a register for recording each good removed from the cart in a transaction entry;
a position at the checkout location for receiving each recorded good;
a means for ascertaining the weight of the goods at the position;
a means for calculating the expected weight of the goods from the transaction entries;
a means for comparing the ascertained weight with the expected weight; and
a means for creating a warning when the ascertained weight exceeds the expected weight, with said warning alerting a cashier at the checkout location to inspect the checkout location for unrecorded goods.

15. A system as recited in claim 14 further comprising a means for storing the ascertained weight, the expected weight, the checkout location, the date and the time.

16. A system for preventing non-payment for goods in a shopping cart having a known tare weight comprising:
a scale for determining an end-weight for the cart after all goods are presumably removed from the cart at a checkout location;
a means for communicating the end-weight;
a controller for receiving the end-weight from the communicating means, with said controller comparing the end-weight with the tare weight, and with said controller creating a signal when the end-weight exceeds the tare weight; and
an indicator at the checkout location, with said indicator receiving the signal from the controller, wherein said indicator alerts a cashier at the checkout location to inspect the cart for unremoved goods in response to receiving the signal.

17. A system as recited in claim 16 further comprising a camera electronically connected to the controller, wherein said camera captures an image of the cart when the end-weight exceeds the tare weight.

18. A system as recited in claim 17 wherein the controller stores the end-weight, the tare weight, the checkout location, and the image of the cart.

19. A system as recited in claim 16 wherein said scale is positioned at the checkout location.

20. A system as recited in claim 16 wherein said scale is mounted to the cart.

21. A method for preventing non-payment for goods in a shopping cart comprising the steps of:
selectively recording visual images of the cart when the cart is positioned at a checkout location;
marking the visual images with a date-time-location stamp;
storing the visual images;
reviewing a sequence of visual images to identify a failure to remove goods from the cart; and
creating a warning when a failure to remove goods from the cart is identified, with said warning alerting a cashier at the checkout location to inspect the cart for unremoved goods.

22. A method as recited in claim 21 further comprising the steps of:
identifying a tare weight for the cart;
determining an end-weight for the cart after all goods are presumably removed from the cart at a checkout location;
comparing the end-weight with the tare weight; and
creating a warning when the end-weight exceeds the tare weight to alert the cashier at the checkout location to inspect the cart for unremoved goods.
